(19) United States
(12) Patent Application Publication
(10) Pub. No.: US 2025/0388160 A1
(43) Pub. Date: Dec. 25, 2025

(54) Easy Entry System with Spring Integrated Track Release

(71) Applicant: Brose Fahrzeugteile SE & Co. Kommanditgesellschaft, Coburg, Coburg (DE)

(72) Inventors: Dakota STAPLETON, Flushing, MI (US); Samruddh KULKARNI, Auburn Hills, MI (US)

(21) Appl. No.: 18/750,633

(22) Filed: Jun. 21, 2024

(51) Int. Cl. B60N 2/90; B60N 2/02; B60N 2/12

(52) U.S. Cl. CPC B60N 2/919; B60N 2/12; B60N 2002/0216; B60N 2002/952

(57) ABSTRACT

Systems and methods for a vehicle seat. The vehicle seat system includes, in one example, a seat lift and track release assembly coupled to a seat frame and including a spring configured to during a first stage of vehicle seat release, exert torque on an entry lever and during a second stage of the vehicle seat release, exert torque on a lifter lever to initiate unlock of a track locking device. Further, in the vehicle seat system, the seat lift and track release assembly includes the lifter lever and the entry lever.

### FIELD

The present description relates generally to an easy entry seat system with a multi-use spring.

### BACKGROUND AND SUMMARY

Easy entry seats have been used in vehicles to enable vehicle users to more effectively access rear seats in the vehicle. To elaborate, the easy entry functionality is a vehicle seat feature where the seat is able to translate forward with little or no change in relation to the relative position between a seating cushion and a backrest. This feature is utilized in many vehicle platforms to allow third row access without having to remove a child seat located in the second row. However, easy entry seats can serve other uses and therefore may be used in other positions in the vehicle.

To achieve the abovementioned easy entry functionality, previous systems have made use of easy entry assist springs that solely lift the seat to assist the end user in seat rotation. Once translation of the seat reaches a predetermined point, the tracks become unlocked using a different mechanism which have included springs or mechanical devices that are configured to drive the track lock open, thereby allowing the seat to slide forward. These systems have included brackets, towel bars, or made use of other mechanisms that rely on kinematic motion to unlock the seat. Thus, separate mechanisms are used to independently lift the seat and unlock the seat for translation.

The inventors have recognized several drawbacks with the abovementioned easy entry seats. For instance, the tolerance stack-up in the seat assembly may be relatively large in some cases, causing ratcheting of the track were the track lock partially opens on one side and drags against the rail, thereby causing undesirable noise, vibration, and harshness (NVH), component degradation, and/or system inoperability, in some instances.

Facing the aforementioned challenges, the inventors developed a vehicle seat system to at least partially address the challenges. The vehicle seat system includes, in one example, a first seat lift and track release assembly coupled to a seat frame. The first seat lift and track release assembly includes an entry lever and a lifter lever. The first seat lift and track release assembly further includes a spring that is configured to during a first stage of vehicle seat release, exert torque on the entry lever and during a second stage of the vehicle seat release, exert torque on the lifter lever to initiate unlock of a track locking device. In the vehicle seat system, the first seat lift and track release assembly includes the lifter lever and the entry lever. In this way, the part count of the seat is reduced (when compared to easy entry seats that use separate mechanisms for lifting the seat and releasing the seat from the track), thereby simplifying the seat, from a manufacturing standpoint. Further, the aforementioned vehicle seat system is able to more effectively manage tolerance stack-up in the seat to reduce the chance (e.g., altogether avoid) NVH caused by track ratcheting as well as seat release inoperability.

In one example, the vehicle seat system may include a release mechanism that is coupled to a splitter cable box. In this example, the splitter cable box is mechanically coupled to the first seat lift and track release assembly and a second seat lift and track release assembly. Further in such an example, the splitter cable box is configured to initiate vehicle seat release in response to operator interaction with the release mechanism. In this way, the release mechanism is able to efficiently release both seat lift and track release assemblies. Further, using two seat lift and track release assemblies allows the likelihood of NVH and release mechanism inoperability to be even further reduced.

In one example, rotational axes of the entry lever, the lifter lever, and the spring may be coaxially arranged. In this way, system space efficiency is further increased. Further in one example, the spring may be a torsion bar spring. In this way, the spring is able to achieve a target spring rate in a package that is able to be space efficiently incorporated into the vehicle seat.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a perspective view of an example of a vehicle seat with an easy entry vehicle seat system.

FIGS. 2A-2D are side views of a release sequence for the vehicle seat using the easy entry vehicle seat system, depicted in FIG. 1.

FIGS. 3A-3E are detailed side views of a seat lift and track release assembly during stages in a release sequence of the vehicle seat, depicted in FIG. 1.

FIGS. 4A-4B are side views of a spring in the seat lift and track release assembly and a vehicle seat at different positions in the release sequence.

FIGS. 5-7 are different detailed perspective views of a portion of the seat lift and track release assembly in the easy entry vehicle seat system, depicted in FIG. 1.

### DETAILED DESCRIPTION

An easy entry vehicle seat system is described herein that functions to cooperatively lift and unlock the seat using mechanisms that are less susceptible to noise, vibration, and harshness (NVH) generation and system inoperability that stem from tolerance stack-up. To achieve these characteristics, the easy entry vehicle seat system includes, in one example, a spring that has multi-use functionality. The first function of the spring involves the application of torque on an easy entry lever when vehicle seat release is initiated and the second function involves the application of torque on a lifter lever that disengages a track locking device such as a comb lock or other suitable device. In some examples, springs, easy entry levers, and lifter levers with the aforementioned characteristics are provided on opposing sides of the seat to further enhance the ability of the system to manage comparatively large tolerance chains in the seating system and avoid NVH and system inoperability that are caused by the larger tolerances in other seat systems. For instance, seat tracks may be out of parallelism (e.g., out of parallelism by up to 10°, in one use-case example) and the spring is able to function as desired to lift the seat via rotation and subsequently disengage the track locking device.

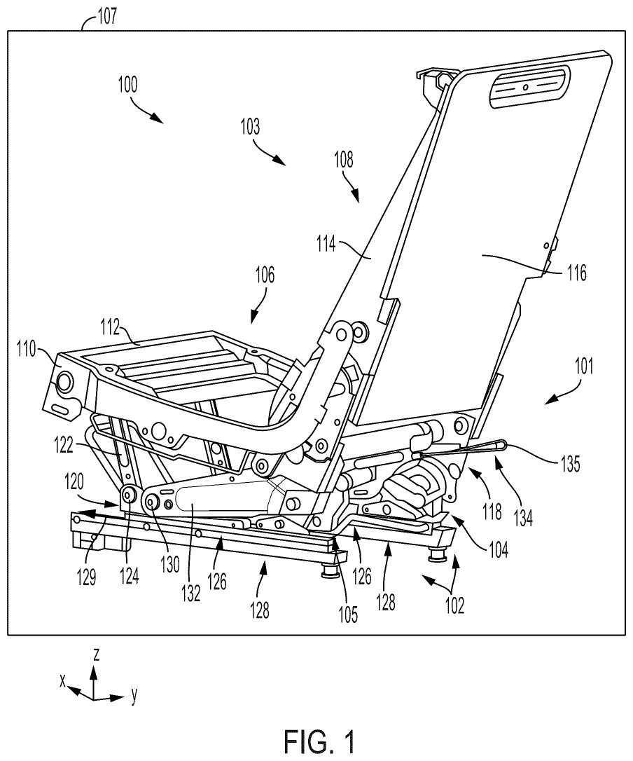

FIG. 1 shows a vehicle seat 100 for a vehicle 107. The vehicle may take a variety of forms including but not limited to wheeled on-road passenger vehicles (e.g., sports utility vehicles (SUVs), trucks, sedans, and the like), commercial vehicles, industrial vehicles, and the like. Further, the vehicle 107 may be an electric vehicle (e.g., an all-electric vehicle, a hybrid electric vehicle, and the like), a vehicle that solely uses an internal combustion engine as a motive power source, etc.

In one use-case example, the vehicle seat 100 may be arranged in a front row of seats in the vehicle to enable access one or more rear rows of seats. However, the vehicle seat may be arranged in a variety of locations within the vehicle, in other examples.

The vehicle seat 100 includes an easy entry system 101. In the illustrated example, the easy entry system 101 includes a pair of seat lift and track release assemblies 102 that are coupled to a seat frame 103. The pair of seat lift and track release assemblies include a seat lift and track release assembly 104 and a seat lift and track release assembly 105. However, easy entry systems with one seat lift and track release assembly have been contemplated.

The seat frame 103 includes a seating portion 106 and a backrest portion 108 that may be designed to receive cushions for the comfort of the occupant. The seating portion 106 may include side supports 110 and a cross support 112 that extends between the side supports, among other components. Similarly, the backrest portion 108 may include (albeit with distinct dimensions) side supports 114 and a cross support 116 that extends between the side supports, among other components.

In the illustrated example, the backrest portion 108 and the seating portion 106 may be removably coupled to one another using fasteners and/or other suitable devices. However, in other examples, the backrest portion 108 may be fixedly coupled to the seating portion 106.

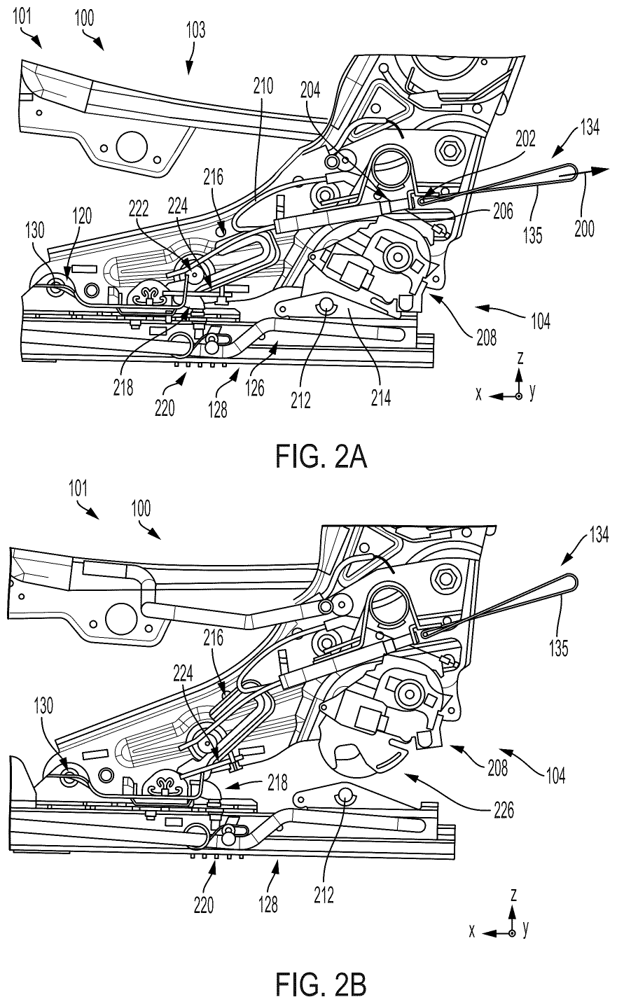

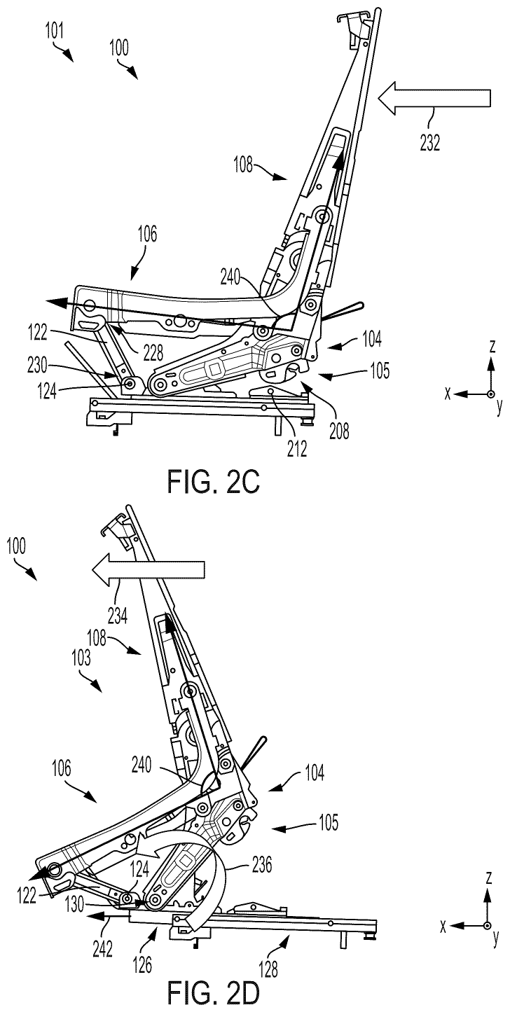

The seating portion 106 may be coupled to a seat frame base 118. Further, the seating portion 106 may be coupled to upper track mounting members 120 (which are discussed in greater detail herein with regard to FIGS. 2A-3E and FIGS. 5-7) via levers 122 on opposing lateral sides of the seat. The levers 122 may rotate about pivots 124 such as bearings (e.g., plain bearings, ball bearings, roller bearings, bushings, and the like). In other examples, one or more of the levers described herein may more generally be formed as link(s), linkages, and the like. The other pivots described herein may also take the form of any of aforementioned types of bearings.

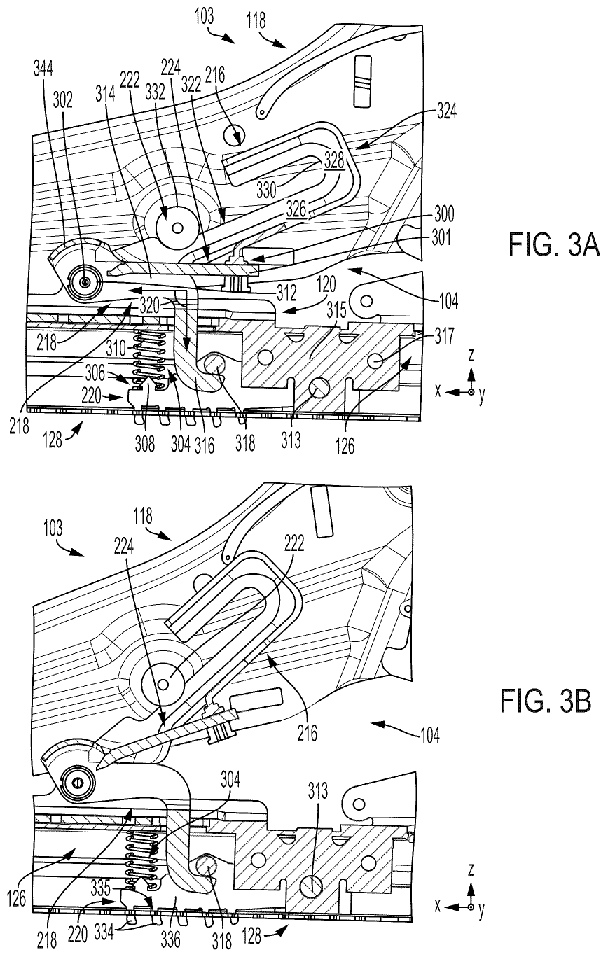

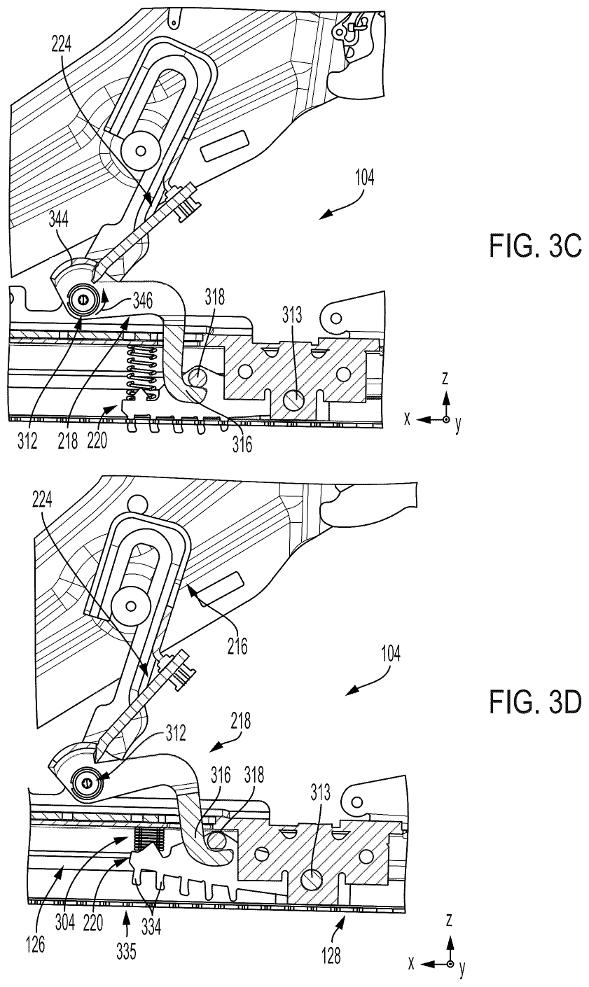

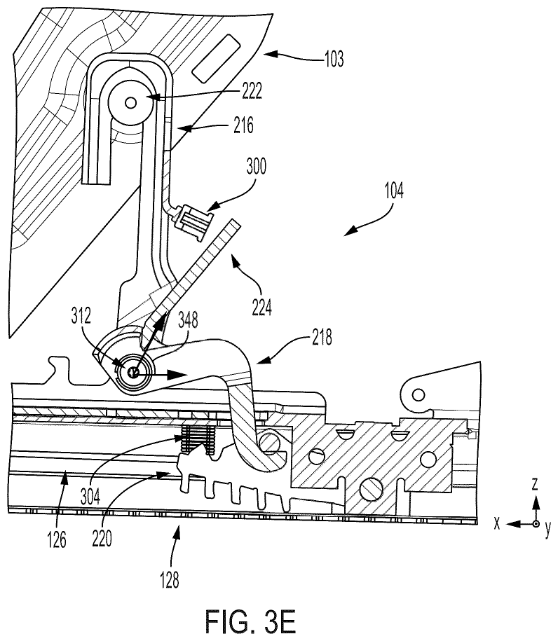

In the illustrated example, each of the seat lift and track release assemblies 104 and 105 is coupled to an upper track 126 and is designed to releasably coupled to a lower track 128 using a track locking device which is discussed in greater detail herein with regard to FIGS. 2A-3E. When the track locking devices are engaged, the relative position between the upper and lower tracks is fixed. Conversely, when the track locking devices are disengaged, the upper track is free to slide along the lower track such that it translates along a longitudinal axis 129.

In the illustrated example, the upper tracks 126 are coupled to upper track mounting members 120. Further, in the illustrated example, the upper track mounting members 120 are rotationally coupled to the seat frame 103 via pivots 130, as discussed in greater detail herein. However, other upper track configurations may be used in the seat in alternate examples. The lower tracks 128 are configured to attach to a vehicle floor via attachment devices (e.g., bolts, screws, etc.), welds, clamps, combinations thereof, and the like.

Further, a cover 132 may be included in each of the seat lift and track release assemblies 104 and 105. The cover 132 may be profiled to protect the seat lift and track release assemblies 104 and 105 from dirt, dust, etc. contamination and degradation from undesirable impacts when users are loading and unloading the vehicle. However, vehicle seats without the cover have been contemplated.

A release mechanism 134 may be included in the easy entry system 101. In the illustrated example, the release mechanism 134 exhibits mechanical functionality, and specifically includes a strap 135. However, a variety of suitable mechanical release mechanism constructions have been contemplated. For instance, the release mechanism may alternatively include a knob, a handle, and the like which are designed for user actuation. Actuation of the release mechanism, by a user, initiates a vehicle seat release sequence that is expanded upon herein with regard to FIGS. 2A-4B. In alternate examples, the release mechanism may include an electro-mechanical device (e.g., a solenoid device, a servo motor actuator, combinations thereof, and the like) that may provide power release functionality to the system. For instance, the release mechanism 134 may include an electrically actuated input device (e.g., a button, a dial, a switch, a touch screen, combinations thereof, and the like) that actuates an electro-mechanical release device. To elaborate, the electro-mechanical device may be directly coupled to or incorporated into latches in the seat lift and track release assemblies 104 and 105 or alternatively may actuate a splitter box that is coupled to the latches and described in greater detail herein, for instance. Generally, the release mechanism 134 functions to initiate the release of easy entry levers, described in greater detail herein.

FIGS. 2A-2D show an exemplary sequence for releasing the vehicle seat 100 using the easy entry vehicle seat system 101. FIG. 2A shows actuation of the strap 135 in the release mechanism 134 by an operator which is represented by an arrow 200. The strap 135 is coupled to an input 202 of a splitter cable box 204. The splitter cable box 204 is mechanically coupled to the seat lift and track release assembly 104 as well as the seat lift and track release assembly 105 via cables 206 and/or other suitable mechanisms, in the illustrated example. To elaborate, the splitter cable box 204 is mechanically coupled to a latch 208 in each of the seat lift and track release assemblies, in the illustrated example. In this way, the splitter box has one input and two outputs for efficient actuation of the seat lift and track release assemblies. The cables 206 are enclosed by housing sections 210, in the illustrated example. However, other configurations of the release mechanism are possible, such as electro-mechanical release mechanisms as previously indicated.

FIG. 2A further shows a pin 212 which the latch 208 is coupled to when engaged. The pin 212 is coupled to the upper track 126 via a mounting member 214 and/or other suitable component. Alternatively, the pin may be directly coupled to the upper track. FIG. 2A further shows an easy entry lever 216 and lifter lever 218 in the seat lift and track release assembly 104. It will be appreciated that the other seat lift and track release assembly 105, shown in FIG. 1, may have a similar configuration.

In the vehicle seat configuration shown in FIG. 2A, the lifter lever 218 interacts with a track locking device 220 that engages the lower track 128. A portion of the track locking device 220 is obscured from view and the functionality of the track locking device is expanded upon herein with regard to FIGS. 3A-3E.

Further, a stop 222 and a spring 224 whose functionality is expanded upon herein are additionally depicted in FIG. 2A. It will be understood that spring 224 is compressed (e.g., at its maximum compression) in the configuration depicted in FIG. 2A. One of the pivots 130 and the upper track mounting members 120 are again depicted in FIG. 2A.

FIG. 2B shows the vehicle seat 100 with the easy entry vehicle seat system 101 that includes the seat lift and track release assembly 104, subsequent to user interaction with the release mechanism 134 and specifically the strap 135. Responsive to user interaction with the release mechanism 134, the latch 208 is released from the pin 212. To elaborate, a pin engagement mechanism 226 in the latch is released. Correspondingly, the latch in the other seat lift and track release assembly is released from the associated pin. FIG. 2B additionally depicts the lifter lever 218 in a position that allows the track locking device 220 to remain engaged with the lower track 128.

Release of the latches 208 causes the spring 224 to exert torque on the easy entry lever 216. Exerting torque on the easy entry lever 216 rotates the seat frame 103 above the pivot 130. In this way, seat lift is initiated. To elaborate, FIG. 2A shows the seat frame 103 lifted to a point of equilibrium between the weight of the vehicle seat 100 and the force of the spring 224 exerted on the easy entry lever 216. In this way, the vehicle seat is prepared for a user to ergonomically push the seat forward.

FIG. 2C specifically depicts the easy entry vehicle seat system 101 with the latch 208 released from the pin 212 to release the seat frame 103 and the seat 100, more generally, at a point of equilibrium between the weight of the vehicle seat 100 and the force of the spring 224, shown in FIG. 2B. Additionally, FIG. 2C depicts the lever 122 and associated pivots 124. To elaborate, an end 228 of the lever 122 is coupled to the seating portion 106 and another end 230 of the lever is coupled to the pivot 124. However, other lever arrangements are possible.

Arrow 232, depicted in FIG. 2C, indicates the force applied to the vehicle seat 100 by a user during the vehicle seat release sequence. To elaborate, the user pushes on the rear of the seat to provide more room to access the vehicle (e.g., provide more room to access seats behind vehicle seat).

In response to the user input on the rear of the vehicle seat 100, the vehicle seat translates, as indicated via arrow 234, and rotates about the pivot 130, as indicated via arrow 236 in FIG. 2D. To elaborate, the upper track 126 slides in direction 242 with regard to the lower track 128 to translate the seat frame 103. In this way, user interaction with the seat enables efficient vehicle access. During the seat lift and translation sequence, the spring 224 shown in FIG. 2B, applies force to both the easy entry lever 216 and the lifter lever 218 shown in FIG. 2B. The details of the multi-use functionality of the spring is elaborated upon herein in relation to FIGS. 3A-7.

In the example illustrated in FIGS. 2C and 2D, an angle 240 between the seating portion 106 and the backrest portion 108 remains substantially unchanged between the equilibrium seat position shown in FIG. 2C and the translated seat position shown in FIG. 2D. In this way, the seat is less likely to spatially interfere with vehicle components in front of the seat, such as another row of seats, for instance. FIG. 2D further shows the lever 122 which rotates above the pivot 124 to enable the lever to support the seat frame during seat release. However, in alternate examples, the angle formed between the backrest and the seating portion may decrease during easy entry seat release.

FIGS. 3A-3E show an exemplary seat release sequence in the seat lift and track release assembly 104. However, it will be appreciated that the other seat lift and track release assembly 105, shown in FIG. 1, experiences a substantially identical sequence, in the illustrated example. Therefore, redundant description is omitted for concision.

FIG. 3A shows the spring 224 at is maximum compression and the track locking device 220 engaged with the lower track 128. As shown, the spring 224 contacts a spring interface extension 300 of the easy entry lever 216 but does not yet apply torque thereto. To elaborate, the spring 224 includes an arm 301 that rotates about a pivot 312 and is contoured to apply torque to the spring interface extension 300 and a track release bracket 344 during different stages of seat release, discussed in greater detail herein.

The lifter lever 218 is further depicted in FIG. 3A. In the illustrated example, the lifter lever 218, the easy entry lever 216, and the spring 224 share a common rotational axis 302. In this way, the packaging efficiency of the system is increased. However, in other examples, the spring 224 may share an axis of rotation with solely one of the lifter lever 218 and the easy entry lever 216 or the easy entry lever and the lifter lever may be coaxially arranged, and the axis of rotation of the spring 224 may parallel to but offset from the axis of rotation of the lifter lever 218 and the easy entry lever 216.

A locking device spring 304 may be coupled to the track locking device 220. To elaborate, one end 306 of the locking device spring 304 mates with a protrusion 308 in the track locking device 220 and another end 310 of the track locking device spring contacts the upper track mounting member 120, in the illustrated example. The locking device spring 304 is in an extended configuration (e.g., an uncompressed configuration) in FIG. 3A. Further the locking device spring 304 is a coil spring in the illustrated example. However, other suitable types of springs may be used in other examples such as leaf springs, Belleville springs, elastomeric springs, and the like.

The pivot 312 of the lifter lever 218 and the easy entry lever 216 is further depicted in FIG. 3A. To elaborate, the pivot 312 may be coupled to the upper track mounting member 120 which is coupled to the upper track 126 or may be directly incorporated into the upper track.

A pivot 313 of the locking device 220 is further illustrated in FIG. 3A. In the illustrated example, the pivot 313 is mounted to the upper track 126 using a plate 315 and attachment devices 317 (pins, screws, clamps, combinations thereof, and the like) and/or other suitable techniques. The locking device 220 rotates about the pivot 313 when it is disengaged, as expanded upon below.

The lifter lever 218 includes a body 314 with an arm 316 that extends therefrom and contacts a pin 318 of the track locking device 220, in the illustrated example. However, other suitable lifter lever configurations may be used in other examples. The arm 316 and body 314 of the lifter lever form an angle 320. The angle 320 may be in the range of 80°-100° in one use-case example. However, the angle 320 may have a variety of suitable values that may be less than or greater than the 80°-100° range, in other examples. The angle 320 may be selected based on based on the system's structural characteristics such as the mounting position of the lifter lever 218 and the upper track 126, the location where the track locking device is pivotally mounted to the upper track, etc. Additionally, the body 314 of the lifter lever 218 is coupled to the pivot 312, in the illustrated example.

The easy entry lever 216 includes a body 322 and a hook 324 in the illustrated example. The body 322 is coupled to the pivot 312 and the hook 324 is profiled to mate with the stop 222. Further, in the illustrated example, the hook 324 includes two parallel sides 326 and a section 328 extending therebetween. A curved surface 330 in the hook 324 may be profiled to contact the outer diameter 332 of the stop 222 to impede further rotation of the easy entry lever when the curved surface contacts the outer diameter of the stop. However, other easy entry lever profiles may be used in other examples. The stop 222 is coupled to the base 118 of the seat frame 103 which pivots and translates during different stages of seat release discussed in greater detail herein.

Once the release mechanism, discussed above, is actuated (e.g., pulled in the illustrated example or electronically actuated, in the electro-mechanical release mechanism example) by the user, the latch 208 is released from the pin 212 (which are shown in FIG. 2B) and the spring 224 rotates the lifter lever 218 due to the torque applied thereto, as shown in FIG. 3B. Further, as shown in FIG. 3B, the track locking device 220 is engaged with the track. To elaborate, the track locking device 220 is depicted as a comb lock with multiple extensions 334 that extend downward from a body 336. The extensions 334 mate with slots 335 in the lower track 128 when the track locking device 220 is engaged, thereby inhibiting the upper track 126 from axially translating in relation to the lower track. Further, the pin 318 is coupled to or formed with the body 336 and extends laterally outward. FIG. 3B again shows the pivot 313, the stop 222, and the base 118 of the seat frame 103. During this initial stage of seat release, the seat frame 103 rotates about the pivot 130 shown in FIG. 1. Further, FIG. 3B shows the tracking locking device spring 304 in an extended configuration (e.g., an uncompressed configuration).

As shown in FIG. 3C, during the stage of the seat release sequence after the latch is release, the spring 224 continues to rotate the easy entry lever 216 and then comes into contact with the track release bracket 344 in the lifter lever 218. As such, the spring 224 applies torque to the lifter lever 218. The track release bracket 344 has a curved profile in the illustrated example. However, the track release bracket 344 may have another suitable shape such as a polygonal shape. The location of the track release bracket may be selected to achieve a desired amount of force demanded for release of the track locking device 220. Further, it will be appreciated that the spring 224 exerts less force on the lifter lever 218 than the easy entry lever 216 during seat release due to their relative positions along the arm of the spring. However, other arrangements of the spring and levers are possible.

The exertion of torque on the lifter lever 218 induces rotation of the lever about the pivot 312 (in direction 346 shown in FIG. 3C) which causes the arm 316 to apply torque to the pin 318. In turn, the track locking device 220 is rotated about a pivot 313 as shown in FIG. 3D. Rotation of the track locking device 220 causes extensions 334 in the track locking device to disengage from slots 335 in the lower track 128. In this way, the upper track 126 is able to translate in relation to the lower track 128.

Rotation of the track locking device 220 compresses the locking device spring 304. The locking device spring 304 allows the track locking device to be re-engaged during a seat engagement sequence (where the sequence of seat release is reversed). Additionally, as shown in FIG. 3D, the spring 224 continues to contact the easy entry lever 216 and induce rotation thereof about the pivot 312.

FIG. 3E shows the easy entry lever 216 rotationally delimited about the pivot 312 by the stop 222. In this way, further rotation of the seat frame is impeded to allow the seat frame 103 to maintain a desired position during subsequent translation. Further, as shown in FIG. 3E, the spring 224 is spaced way from the easy entry lever 216 (and specifically the spring interface extension 300) and therefore does not apply torque thereto. Even further, as shown in FIG. 3E, the spring 224 continues to contact the lifter lever 218 to hold the track locking device 220 in a released position such that the upper track 126 is able to translate in relation to the lower track 128. The angle 348 at which the easy entry lever 216 releases from the spring 224 is indicated in FIG. 3E. The angle 348 may be approximately 49°, in one use-case example. However, the angle may be increased or decreased based on end-use vehicle platform design objectives. It will be appreciated that the locking device spring 304 remains compressed in FIG. 3E.

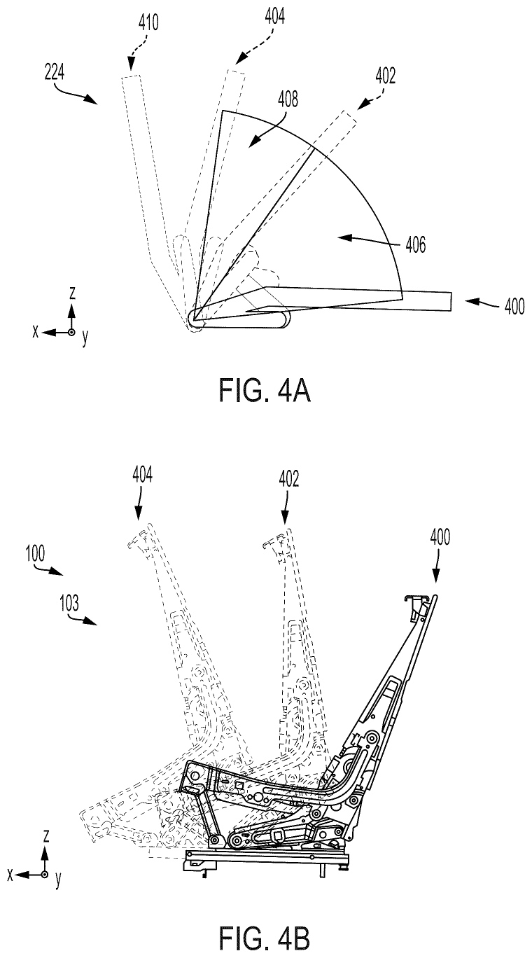

FIGS. 4A-4B show the spring 224 and the vehicle seat 100 and specifically the seat frame 103 in sequential positions at different stages in the seat release sequence. The different sequential positions of the spring 224 and the seat frame 103 shown in FIGS. 4A and 4B, correspond to one another.

At a first position 400, the associated latch is engaged and the spring is at its maximum compression. At a second position 402, the track release is initiated via disengaging the track locking device. At a third position 404, the easy entry lever reaches its maximum rotation which is delimited by the stop. In this way, the seat is at its full easy entry position with the upper track released from the lower track.

The spring functions to solely lift the seat frame in the window of time from the first position 400 to the second position 402 (indicated at 406). The spring functions to solely release the upper track from the lower track via the track locking device in the window of time from the second position 402 to the third position 404 (indicated at 408). In this way, the spring 224 performs an effective hand-off in relation to the application of force on the easy entry lever and the lifter lever. Consequently, the easy entry system is able to provide a multi-use (e.g., dual-use) functionality in a space efficient package that less susceptible to NVH and inoperability when compared to systems which have separate mechanisms for lifting the seat and unlocking the seat from a track. FIG. 4B further shows the spring 224 in an uncompressed position at 410.

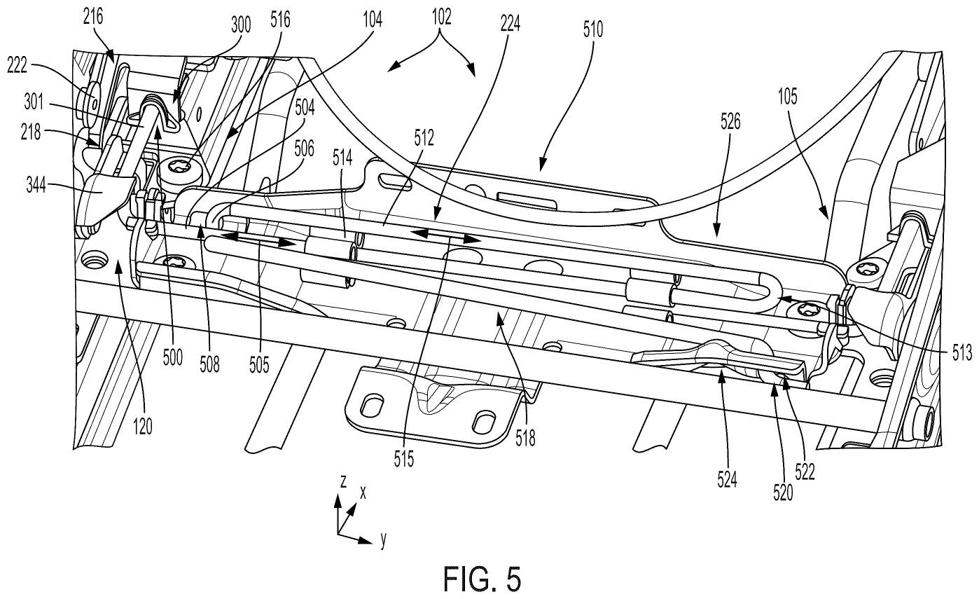

FIG. 5 shows a detailed view of portions of the pair of seat lift and track release assemblies 102. To elaborate, the seat lift and track release assembly 104 is depicted along with the other seat lift and track release assembly 105.

The spring 224 is shown mated with a recess 500 in the spring interface extension 300 of the easy entry lever 216. In this way, the spring 224 is held in a secured position when contacting the easy entry lever 216 and applying torque thereto to rotate the lever during a portion of the seat release sequence.

The track release bracket 344 in the lifter lever 218 is further depicted in FIG. 5. As discussed above, the spring 224 contacts the track release bracket 344 in the lifter lever during a stage of the seat release sequence. However, the spring 224 is not in contact with the track release bracket 344 in the spring position depicted in FIG. 5.

The spring 224 is depicted as a torsion spring (e.g., a U-bend torsion bar spring), in the illustrated example. In this way, the spring is able to be space efficiently incorporated into the vehicle seat. In such an example, the spring 224 includes the arm 301 that is profiled to contact the easy entry lever 216 and the lifter lever 218 during different periods of seat release. The arm 301 may be longitudinally aligned when the spring 224 in its first positon and at maximum compression. However, in other examples, the spring 224 may be a clock spring where a sheet of metal is spirally wound.

The spring 224 may be constructed out of steel to achieve a desired spring rate and durability. Further, at least a portion of the other components in the seat lift and track release assembly may be constructed out of steel (e.g., a high strength steel), another suitable metal, and the like. Plastic may additionally or alternatively be used to construct one or more of the components in the seat lift and track release assembly, in certain examples.

The spring 224 includes another section 504 that is laterally aligned and therefore is perpendicular to the arm 301, in the illustrated example. However, other spring contours may be used.

An axis 505 of the spring section 504 may form a primary axis of the spring. The spring section 504 is coupled to another spring section 512 (which is laterally aligned) via a U-bend 513. In this way, the wire length of the spring is able to be increased to achieve a desired spring rate. An axis 515 of the spring section 512 forms a secondary axis of the spring, in the illustrated example. The primary axis and the secondary axis both work in torsion. To elaborate, the spring section 512 forming the secondary axis undergoes rotation and translation and the U-bend 513 translates the rotational moment from the primary axis to the secondary axis.

Additionally, an end 506 of the spring 224 mates with an opening 508 in a cross-member 510, in the illustrated example. Further, the length and the wire diameter of the various spring sections may be altered to achieve a target spring rate which may be selected based on the weight of the seat, the desired equilibrium positon of the seat during release, the dimensions of the seat, and the like.

The spring section 504 may be held in a desired positon using a spring retainer 514 that is coupled to the cross-member 510 that extends between the upper tracks and specifically coupled to the upper track mounting members 120 using attachment devices 516 and/or other suitable techniques.

Another spring 518 associated with the other seat lift and track release assembly 105 is further depicted in FIG. 5. The spring 518 is retained by the spring retainer 514, in the illustrated example. The spring 518 and the other components in the seat lift and track release assembly 105 are similar to the spring 224 in the seat lift and track release assembly 104. Therefore, redundant description is omitted for concision. However, as shown in FIG. 5, the spring 518 and the spring 224 are offset along a longitudinal axis to increase system space efficiency. Additionally, as depicted in FIG. 5, an end 520 of the spring 518 mates with an opening 522 on a front side 524 of the cross-member 510 and the end 506 of the spring 224 mates with the opening 508 which is on the rear side 526 of the cross-member. However, the springs may be packaged in another suitable manner in alternate embodiments. The stop 222 is further depicted in FIG. 5.

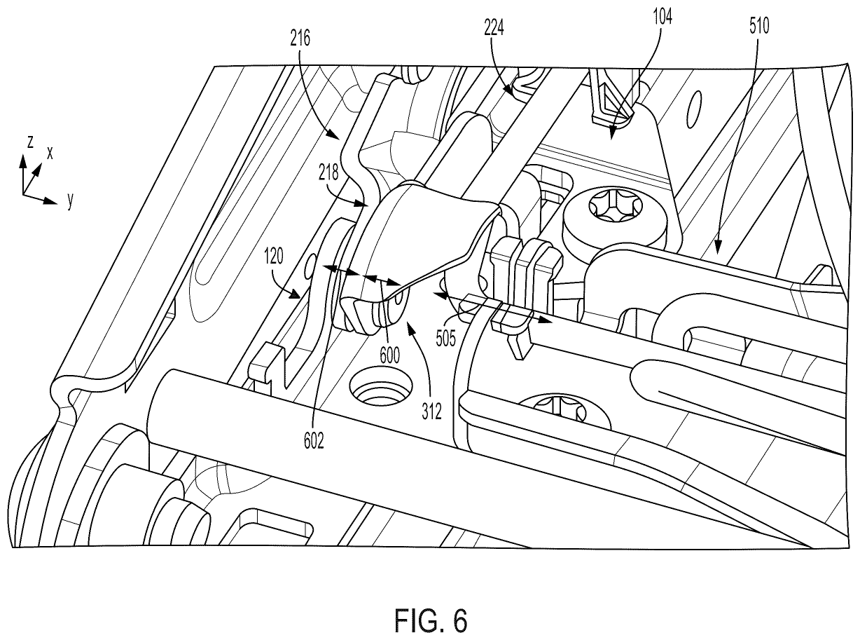

FIG. 6 depicts a portion of the seat lift and track release assembly 104. Specifically, the easy entry lever 216 and the lifter lever 218 which are coupled to the pivot 312 and independently rotate about the pivot are again illustrated in FIG. 6. The spring 224, the upper track mounting member 120, and the cross-member 510 are further depicted in FIG. 6. The pivot 312 is coupled to the upper track mounting member 120 in the illustrated example. However, other pivot arrangements are possible.

An axis 600 of the lifter lever 218, an axis 602 of the easy entry lever 216, and the axis 505 (e.g., a primary axis) of the spring 224 are illustrated in FIG. 6. The axes 600, 602, and 505 are coaxially aligned, in the illustrated example. In this way, the system is more efficiently packaged and the components experience little to no sliding. In other examples, the axes 600 and 602 may be coaxially arranged and the axis 505 may be parallel to but offset from the axes 600 and 602. In other examples, solely one of the axes 600 and 602 may be coaxially arranged in relation to the axis 505.

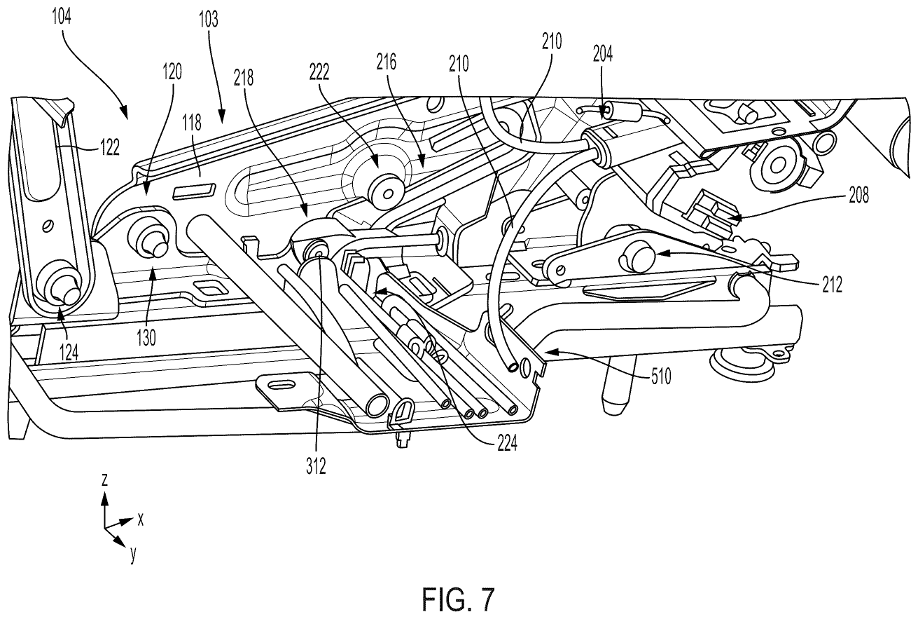

FIG. 7 illustrates another view of the seat lift and track release assembly 104. Specifically, the easy entry lever 216, the lifter lever 218, the pivot 312, the upper track mounting member 120, and the cross-member 510 are again depicted. FIG. 7 further shows the pivot 130 about which the base 118 of the seat frame 103 rotates. The lever 122 which rotates about the pivot 124 is further shown in FIG. 7.

The stop 222, the spring 224, and the splitter cable box 204 which is coupled to cables enclosed by housing sections 210 are further depicted in FIG. 7. As discussed above, the splitter cable box enables the seat lift and track release assemblies to be efficiently actuated. However, other actuation mechanisms are possible, in other embodiments, as previously discussed. Additionally, the latch 208 and the pin 212 are further shown in FIG. 7. The spring 224 is in its compressed positon prior to seat release in the system configuration shown in FIG. 7.

The easy entry vehicle seat system described herein enable springs in the seat lift and track release assemblies to achieve a multi-use functionality, the first function being seat frame rotation and the second function being track locking device disengagement to increase the space efficiency and simplify construction of the system. Additionally, the seat frame and vehicle seat system may more easily manage the tolerance chain in the seat assembly to avoid undesirable NVH caused by track ratcheting and track release inoperability.

FIGS. 1-7 provide for a method for operation of an easy entry vehicle seat system such as the easy entry vehicle seat system described above or another suitable easy entry vehicle seat system. The method includes receiving a user input that actuates a release mechanism. For instance, the user may pull a release strap or other suitable release mechanism. In other examples, the user may actuate an electronic input device, which electronically actuates an electro-mechanical release mechanism. In response to receiving the user input, vehicle seat release is initiated in the easy entry vehicle seat system. During release of the vehicle seat, latches are disengaged to initiate a first stage of vehicle seat release where a first spring exerts torque on a first easy entry lever. Further, during a second stage of vehicle release springs exert torque on lifter levers to initiate unlock of associated track locking devices. It will be appreciated that the vehicle seat release step is passively implemented responsive to actuation of the release mechanism.

An axis system is provided in FIG. 1 as well as FIG. 2A-7, for reference. The z-axis may be a vertical axis (e.g., parallel to a gravitational axis), the y-axis may be a lateral axis (e.g., horizontal axis), and/or the x-axis may be a longitudinal axis, in one example. However, the axes may have other orientations, in other examples. FIGS. 1-7 are drawn approximately to scale. However, other relative component dimensions may be used, in other embodiments.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottom most element or point of the element may be referred to as a “bottom” of the component, in at least one example. Further still, an element shown within another element or shown outside of another element may be referred as such, in one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example.

The invention will further be described in the following paragraphs. In one aspect, a vehicle seat system is provided that comprises a first seat lift and track release assembly coupled to a seat frame and including: a lifter lever and an entry lever; a spring configured to: during a first stage of vehicle seat release, exert torque on the entry lever; and during a second stage of vehicle seat release, exert torque on the lifter lever to initiate unlock of a track locking device. In one example, the spring may be further configured to release from the entry lever after a predetermine amount of angular rotation of the entry lever during the second stage of the vehicle seat release. Further, in one example, rotational axes of the entry lever, the lifter lever, and the spring may be coaxially arranged. Further, in one example, the spring may be a torsion bar spring. Even further, in one example, the spring may be a clock spring. Additionally, in one example, the vehicle seat system may further comprise a release strap coupled to a splitter cable box that is mechanically coupled to the first seat lift and track release assembly and a second seat lift and track release assembly, wherein the splitter cable box is configured to initiate vehicle seat release in response to operator interaction with the release strap. Even further, in one example, the track locking device may include a comb lock that mates with recesses in a track when in a locked position. The vehicle seat system may further include, in one example, a stop configured to delimit rotation of the entry lever during the release of the vehicle seat. In another example, an angle formed between a first portion of a frame and a second portion of the frame may remain fixed during the first stage and the second stage of vehicle seat release.

In another aspect, a vehicle seat system is provided that comprises a seat lift and track release assembly coupled to a seat frame and including: a spring that rotates about a pivot and sequentially rotates an entry lever and lifter lever via an arm during seat release, the lifter lever disengaging a track locking device via the rotation, disengagement of the track locking device disengaging an upper track from a lower track, the seat frame coupled to the upper track. In one example, the spring may be a torsion bar spring or a clock spring. The vehicle seat system may further comprise, in one example, a hard stop configured to delimit rotation of the entry lever during seat release. The vehicle seat system may further comprise, in another example, a release strap coupled to a splitter cable box that is mechanically coupled to the first seat lift and track release assembly and a second seat lift and track release assembly, wherein the splitter cable box is configured to initiate vehicle seat release in response to operator interaction with the release strap, and wherein an angle formed between a first portion of the seat frame and a second portion of the seat frame remains fixed during the first stage and the second stage of release. In another example, the track locking device may include a comb lock that mates with recesses in the lower track when in an engaged position. Even further in another example, the spring, the lifter lever, and the entry lever may be coaxially arranged in relation to their axes of rotation.

In another aspect, a method for operation of a vehicle seat system is provided that comprises releasing a vehicle seat by: releasing a first latch to initiate a first stage of vehicle seat release where a first spring exerts torque on a first entry lever; and a second stage of vehicle seat release where the first spring exerts torque on a first lifter lever to initiate unlock of a first track locking device; wherein the first spring, the first entry lever, the first lifter lever, and the first track locking device are included in a first seat lift and track release assembly that is coupled to a seat frame and included in the vehicle seat system. In one example, during a portion of the second stage of vehicle seat release, the first spring may exert a torque on the first entry lever. Further, in another example, the vehicle seat may be released in response to an operator actuating a release mechanism; the release mechanism is configured to mechanically or electro-mechanically actuate the first latch and a second latch; the second latch may be included in a second seat lift and track release assembly; and the vehicle seat release may include: releasing the second latch to initiate the first stage of vehicle seat release where a second spring exerts torque on a second entry lever; and the second stage of vehicle seat release where the second spring exerts torque on a second lifter lever to initiate disengagement of a second track locking device. Even further, in another example, the first spring and the second spring may be torsion bar springs. In yet another example, rotational axes of the first spring, the first entry lever, and/or the first lifter lever may be coaxially arranged.

In another aspect, an easy entry vehicle seat system is provided that comprises a pair of seat lift and track release assemblies coupled to a seat frame and each including: a spring configured to: during a first stage of vehicle seat release, exert torque on an easy entry lever; and during a second stage of the vehicle seat release, exert torque on a lifter lever to initiate unlock of a track locking device. In one example, the spring may be a torsion bar spring or a clock spring. In another example, the easy entry vehicle seat system may further comprise a hard stop configured to delimit rotation of the easy entry lever during axial translation of the seat frame along a pair of tracks. In another example, an angle formed between a first portion of the seat frame and a second portion of the seat frame may remain fixed during the first stage and the second stage of release. In another example, the track locking devices may be comb locks that mate with recesses in tracks when in locked positions; and the seat frame may be configured to axially translate along the tracks when the track locking devices are unlocked. In another example, in each of the seat lift and track release assemblies in the pair of seat lift and track release assemblies, the spring, the lifter lever, and the easy entry lever may be coaxially arranged in relation to their axes of rotation.

It will be appreciated that the configurations and routines disclosed herein are exemplary in nature, and that these specific embodiments are not to be considered in a limiting sense, because numerous variations are possible. For example, the above technology can be applied to a broad range of vehicles including but not limited to passenger vehicles, commercial vehicles, on and off road vehicles, light duty vehicles, medium duty vehicle, heavy duty vehicles, etc. The subject matter of the present disclosure includes all novel and non-obvious combinations and sub-combinations of the various systems and configurations, and other functions, features, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, elements, functions, and/or properties may be claimed through amendment of the present claims or through presentation of new claims in this or a related application. Such claims, whether narrower, broader, equal, or different in scope to the original claims, also are regarded as included within the present disclosure's subject matter.

1. A vehicle seat system, comprising:
a first seat lift and track release assembly coupled to a seat frame and including:
a lifter lever and an entry lever;
a spring configured to:
during a first stage of vehicle seat release, exert torque on the entry lever; and
during a second stage of vehicle seat release, exert torque on the lifter lever to initiate unlock of a track locking device.

2. The vehicle seat system of claim 1, wherein the spring is further configured to release from the entry lever after a predetermined amount of angular rotation of the entry lever during the second stage of the vehicle seat release.

3. The vehicle seat system of claim 1, wherein rotational axes of the entry lever, the lifter lever, and the spring are coaxially arranged.

4. The vehicle seat system of claim 1, wherein the spring is a torsion bar spring.

5. The vehicle seat system of claim 1, wherein the spring is a clock spring.

6. The vehicle seat system of claim 1, further comprising a release strap coupled to a splitter cable box that is mechanically coupled to the first seat lift and track release assembly and a second seat lift and track release assembly, wherein the splitter cable box is configured to initiate vehicle seat release in response to operator interaction with the release strap.

7. The vehicle seat system of claim 1, wherein the track locking device includes a comb lock that mates with recesses in a track when in a locked position.

8. The vehicle seat system of claim 1, further comprising a stop configured to delimit rotation of the entry lever during the release of the vehicle seat.

9. The vehicle seat system of claim 1, wherein an angle formed between a first portion of a frame and a second portion of the frame remains fixed during the first stage and the second stage of vehicle seat release.

10. An vehicle seat system, comprising:
a first seat lift and track release assembly coupled to a seat frame and including:
a spring that rotates about a pivot and sequentially rotates an entry lever and lifter lever via an arm during seat release, the lifter lever disengaging a track locking device via the rotation, disengagement of the track locking device disengaging an upper track from a lower track, the seat frame coupled to the upper track.

11. The vehicle seat system of claim 10, wherein the spring is a torsion bar spring or a clock spring.

12. The vehicle seat system of claim 10, further comprising a hard stop configured to delimit rotation of the entry lever during seat release.

13. The vehicle seat system of claim 10, further comprising a release strap coupled to a splitter cable box that is mechanically coupled to the first seat lift and track release assembly and a second seat lift and track release assembly, wherein the splitter cable box is configured to initiate vehicle seat release in response to operator interaction with the release strap, and wherein an angle formed between a first portion of the seat frame and a second portion of the seat frame remains fixed during a first stage and a second stage of release.

14. The vehicle seat system of claim 10, wherein the track locking device includes a comb lock that mates with recesses in the lower track when in an engaged position.

15. The vehicle seat system of claim 10, wherein the spring, the lifter lever, and the entry lever are coaxially arranged in relation to their axes of rotation.

16. A method for operation of a vehicle seat system, comprising:
releasing a vehicle seat by:
releasing a first latch to initiate a first stage of vehicle seat release where a first spring exerts torque on a first entry lever; and
operating a second stage of vehicle seat release where the first spring exerts torque on a first lifter lever to initiate unlock of a first track locking device;
wherein the first spring, the first entry lever, the first lifter lever, and the first track locking device are included in a first seat lift and track release assembly that is coupled to a seat frame and included in the vehicle seat system.

17. The method of claim 16, wherein during a portion of the second stage of vehicle seat release, the first spring exerts a torque on the first entry lever.

18. The method of claim 16, wherein:
the vehicle seat is released in response to an operator actuating a release mechanism;
the release mechanism is configured to mechanically or electro-mechanically actuate the first latch and a second latch;
the second latch is included in a second seat lift and track release assembly; and
the vehicle seat release includes:
releasing the second latch to initiate the first stage of vehicle seat release where a second spring exerts torque on a second entry lever; and
the second stage of vehicle seat release where the second spring exerts torque on a second lifter lever to initiate disengagement of a second track locking device.

19. The method of claim 18, wherein the first spring and the second spring are torsion bar springs.

20. The method of claim 16, wherein rotational axes of the first spring, the first entry lever, and/or the first lifter lever are coaxially arranged.
